(19) United States
(12) Patent Application Publication
(10) Pub. No.: US 2013/0154249 A1
(43) Pub. Date: Jun. 20, 2013

(54) APPARATUS AND METHOD FOR DOCUMENT BINDING

(71) Applicant: David Seid, Phoenix, AZ (US)

(72) Inventor: David Seid, Phoenix, AZ (US)

(21) Appl. No.: 13/766,399

(22) Filed: Feb. 13, 2013

Related U.S. Application Data
(63) Continuation-in-part of application No. 12/896,693, filed on Oct. 1, 2010, now abandoned.
(60) Provisional application No. 61/248,096, filed on Oct. 2, 2009.

(51) Int. Cl. B42D 1/00

(52) U.S. Cl. CPC B42D 1/00
USPC 281/21.1

(57) ABSTRACT

A book binding apparatus and a method of bookbinding are provided. In a first aspect, the apparatus includes a book cover with a front cover, rear cover, and a middle portion, bound through the rear cover with two parallel rows of offset cover holes, and a helix coil component configured to hold pages inside the book cover, so the book may lie flat when opened. In a second aspect, the method includes cutting two rows of offset holes into the backing or self-cover of a book, holding a coil (spiral helix) wire by the offset holes to bind pages of a book to the cover, wrapping a cover around the coil, the cover including a spine, and imprinting identifying features on the spine of the book.

### CROSS REFERENCE TO RELATED APPLICATIONS

This application is a continuation-in-part of the earlier U.S. Utility Patent Application to Seid entitled “APPARATUS AND METHOD FOR DOCUMENT BINDING,” Ser. No. 12/896,693, filed Oct. 1, 2010, which claims priority to U.S. Provisional Patent Application to Seid entitled “APPARATUS AND METHOD FOR DOCUMENT BINDING,” Ser. No. 61/248,096, filed Oct. 2, 2009, the disclosures of which are incorporated entirely herein by reference.

### BACKGROUND

1. Technical Field

This disclosure relates generally to book bindings and in particular to a binding apparatus for effectively binding documents to a cover and a method of binding documents to the cover using the same.

2. State of the Art

Traditional methods of book binding often involve spiral and twin loop wire binding configurations. These configurations incorporate wire being placed in and through holes punched near the edges of the pages to be bound.

In spiral binding, holes are made in a straight line along the edge of the page using a predetermined pitch hole pattern, most typically in a 4:1 hole pattern (four holes in a line per inch). Thereafter, the spiral coil binding spine may be threaded through the series of holes to bind the pages together and permit the pages to rotate about the spine.

In twin loop wire binding, holes are made in a straight line along the edge of the page using a predetermined pitch hole pattern, most typically in a 3:1 or 2:1 hole pattern (three holes in a line per inch or two holes in a line per inch). Thereafter, double loops of wire in a c-shape are inserted into the holes and a wire closer squeezes the c-shape spine until it is round.

In either case, it is impossible to imprint the spine of these bound documents with any identifying information, such as the title, author, publisher, or year of publication. Moreover, the bindings themselves may be subject to bending and torque due to the prominence and configuration of the binding. Once the binding is bent from its original shape, it is significantly more difficult to rotate the bound pages around the altered binding.

There is thus a need in the document binding industry for a new and improved binding apparatus and method of use thereof.

### SUMMARY

The present disclosure relates generally to book bindings and in particular to a binding apparatus for effectively binding documents to a cover and a method of binding documents to the cover using the same.

An aspect of the present disclosure includes book apparatus, comprising a book cover having hinged portions that define a back section, a middle section, and a front section of the book cover, the middle section being configured between the hinged portions, the book cover being configured to transition between an open position and a closed position, a plurality of rows of holes being configured in the back section of the book cover, a binding component functionally coupled to the plurality of rows of holes, and pages functionally coupled to the binding component and configured to rotate about the binding component, wherein in the open position the front section, middle section, and back section are configured to lay flat on a surface with the binding component and pages exposed on the back section, and wherein in the closed position the book cover is configured to bend about the hinged portions to wrap the book cover over the binding component and the pages to cover the binding component and the pages.

Another aspect of the present disclosure includes wherein the plurality of rows of holes are aligned on the back section substantially in parallel with one another or wherein the plurality of rows of holes are aligned on the back section substantially in parallel with the hinged portions.

Another aspect of the present disclosure includes wherein the binding component is functionally coupled only to the back section, such that the middle section and the front section move independently of the binding component.

Another aspect of the present disclosure includes wherein the book cover comprises first and second hinged portions, wherein the middle section is configured to bend with respect to the back section about the first hinged portion, and the front section is configured to bend with respect to the middle section about the second hinged portion, such that in the closed position the middle section is configured proximate the binding component and the front section is configured proximate the pages.

Another aspect of the present disclosure includes wherein the binding component is a helical coil, the helical coil being functionally coupled to the back section by threading the helical coil through the plurality of rows of holes.

Another aspect of the present disclosure includes wherein the binding component is a helical coil and the pages are functionally coupled to the helical coil by threading the helical coil through holes in the pages, such that under the condition the book cover is placed in the closed position the pages are configured on the binding component between the back cover and the front cover.

Another aspect of the present disclosure includes wherein the plurality of rows of holes are offset an offset distance from one another in the direction of travel of the row of holes.

Another aspect of the present disclosure includes wherein the binding component is a helical coil and the offset distance corresponds to an angle of the helical coil.

Another aspect of the present disclosure includes a book apparatus, comprising a book cover having two hinged portions that define a back section, a middle section, and a front section of the book cover, the middle section being configured between the two hinged portions, the book cover being configured to transition between an open position and a closed position, two rows of holes being configured only in the back section of the book cover, the two rows of holes being substantially parallel with the two hinged portions, and a helical coil functionally coupled to the two rows of holes by threading the helical coil through each of the two rows of holes, and wherein in the open position the front section, middle section, and back section are configured to lay flat on a surface with the helical coil exposed on the back section, and wherein in the closed position the book cover is configured to bend about the hinges to surround the helical coil, the middle section being configured to bend about the first hinged portion with respect to the back section and the front section being configured to bend about the second hinged portion with respect to the middle section, such that the middle section is proximate the helical coil and the front section extends over the back section.

Another aspect of the present disclosure includes a book apparatus, comprising a book cover having two hinged portions that define a back section, a middle section, and a front section of the book cover, the middle section being configured between the two hinged portions, the book cover being configured to transition between an open position and a closed position, two rows of holes being configured only in the back section of the book cover, the two rows of holes being aligned substantially in parallel with the two hinged portions, a perforation being configured in the back section of the book cover, the perforation being aligned substantially in parallel with the two rows of holes, and a helical coil functionally coupled to the two rows of holes by threading the helical coil through each of the two rows of holes, and wherein in the open position the front section, middle section, and back section are configured to lay flat on a surface with the helical coil exposed on the back section, and wherein in the closed position the book cover is configured to bend about the hinges to surround the helical coil, the middle section being configured to bend about the first hinged portion with respect to the back section and the front section being configured to bend about the second hinged portion with respect to the middle section, such that the middle section is proximate the helical coil and the front section extends over the back section.

Another aspect of the present disclosure includes wherein the perforation defines a bendable part of the back section, the bendable part being configured to bend about the perforation with respect to the remainder of the back section.

Another aspect of the present disclosure includes wherein the perforation defines a removable part of the back section, the removable part being configured to detach from the remainder of the back section at the perforation.

Another aspect of the present disclosure includes wherein the perforation comprises a first preformation and a second perforation, the first perforation being aligned in parallel with the rows of holes and defining a part of the back section, the second perforation being configured on the part and aligned orthogonal to the first perforation, such that the second perforation divides the part of the back section into a first part and a second part, and wherein the first and second parts are bendable about the first perforation with respect to the remainder of the back section and the first and second parts are bendable about the second perforation with respect to one another.

Another aspect of the present disclosure includes wherein the first and second parts are configured to be detached from the remainder of the back section along the first perforation and the first and second parts are configured to be detached from one another along the second perforation.

Another aspect of the present disclosure includes a method of binding a book, the method comprising providing a book cover having hinged portions defining a back section, a middle section, and a front section of the book cover, the book cover configured to lay flat, creating a plurality of rows of holes in the back section of the cover, functionally coupling a binding component to the plurality of rows of holes, functionally coupling loose-leaf pages to the binding component; and bending the middle section and the front section at the hinge portions over the binding component and the pages to position the binding component and the pages between the back section and the front section.

Another aspect of the present disclosure includes wherein the bending the middle section and the front section at the hinge portions further comprises moving the middle section with respect to the back portion at the first hinged portion; and moving the front section with respect to the middle portion at the second hinged portion.

Another aspect of the present disclosure includes wherein the creating a plurality of rows of holes further comprises punching the plurality of rows of holes with machinery.

Another aspect of the present disclosure includes wherein the creating a plurality of rows of holes further comprises offsetting the plurality of rows of holes an offset distance from one another in a direction of travel of the rows of holes.

Another aspect of the present disclosure includes wherein the functionally coupling a binding component further comprises threading a helical coil through the plurality of rows of holes, and wherein the functionally coupling loose-leaf pages further comprises threading a helical coil through holes in the pages.

Another aspect of the present disclosure includes wherein the middle section defines a spine of the book, and the method further comprises imprinting on the spine, such that under the condition the middle section and front section are bent over the binding component and the pages, the imprinting on the spine is visible.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

Some of the embodiments will be described in detail, with reference to the following figures, wherein like designations denote like members:

FIG. 1 is an interior view of an open configuration of an embodiment of the book apparatus in accordance with the present disclosure.

FIG. 2 is a perspective view of the closed configuration of an embodiment of the book apparatus in accordance with the present disclosure.

FIG. 3 is a back view of an embodiment of the book apparatus in accordance with the present disclosure.

FIG. 4 is a back view of an embodiment of the book apparatus in accordance with the present disclosure.

FIG. 5 is a back view of an embodiment of the book apparatus in accordance with the present disclosure.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

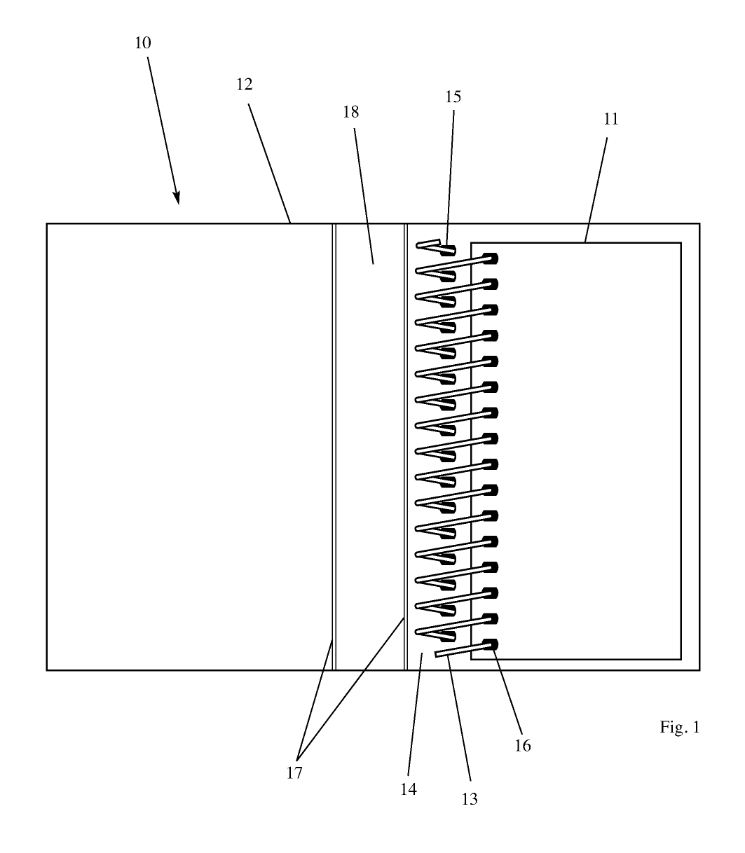

Referring now to the invention in more detail, in FIG. 1 there is shown a book 10. Embodiments of the book 10 may comprise pages 11 that may be functionally bound to a cover 12 by means of a helix (coil or spiral) component 13. Each of the pages 11 may be functionally coupled to the cover 12 by means of the coil (spiral) component 13 inserted through a single row of page holes 16 cut through the pages 11 and through two parallel rows of offset cover holes 15 (of which one row is visible in this view) that are cut through the cover 12. Embodiments of the book 10 further comprise hinge points 17 configured in the cover 12 for folding around the helix (coil or spiral) component 13 to form a cased-in (self) cover 12.

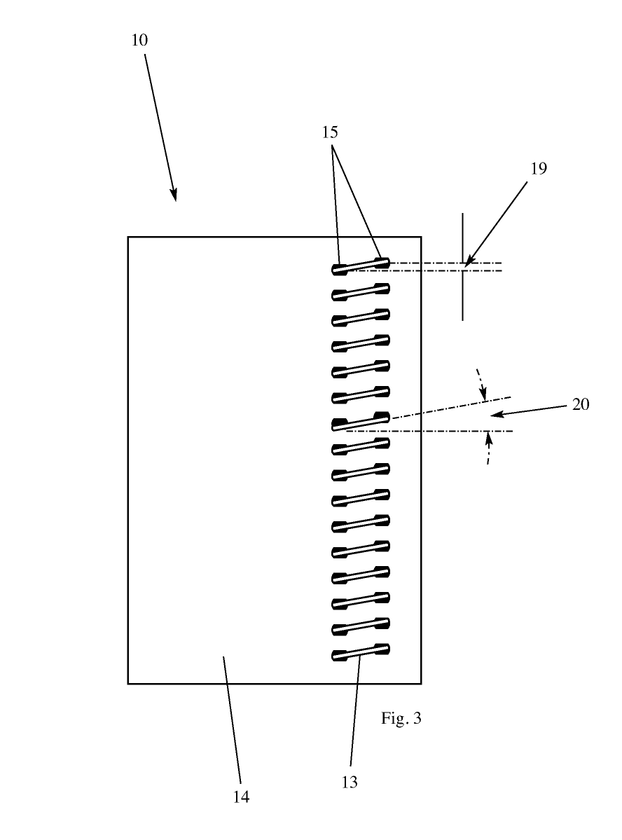

Embodiments of the book 10 may further comprise the pages 11 of the book 10 being bound to the backing or back surface 14 of the cover 12 by the component 13 inserted through the page holes 16 and through two parallel rows of offsetting cover holes 15 in the back surface 14 (see FIGS. 1 and 3).

Embodiments of the book 10 may further comprise the two parallel rows of cover holes 15 (of which one row is visible in FIG. 1) being parallel to the spine 18 of the book 10, the spine 18 of the book 10 being defined between opposing parallel hinge points 17 in the cover 12. Embodiments of the book 10 may further comprise the two parallel rows of cover holes 15 (of which one row is visible in FIG. 1) being offset from one another.

Embodiments of the book 10 may further comprise the book 10 being configured, when in an open position, as depicted in FIG. 1, to lay flat on a work surface, table, podium or other generally flat surface.

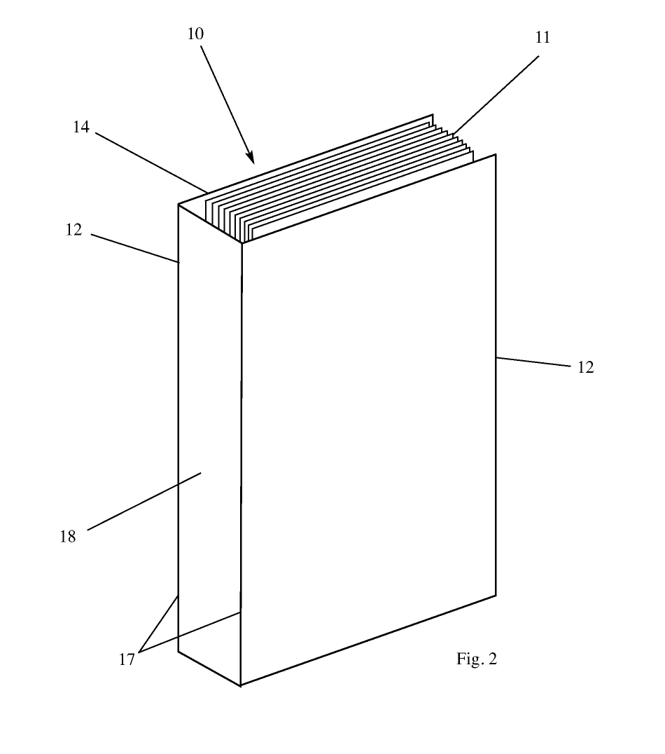

Embodiments of the book 10 may further comprise the book 10 being configurable to be bound with a varying quantity of pages 11 of varying materials such as paper, plastic, veneers and the like. Further, the sizes of the pages 11 can vary. Likewise, the cover 12 may be configured of varying size to match the size, shape, and quantity of the pages 11. The cover 12 may also be configured to be of a size either larger or smaller than the size, shape, and quantity of the pages 11, as the case may be. For example, as depicted in FIG. 1, the cover 12, including the back surface 14 of the cover 12 may be larger than the size of the pages 11, such that the pages 11 do not extend over the back surface 14. In this way, under the condition the cover 12 is folded over the pages, as depicted in FIG. 2, the pages 11 may be protected, concealed, sheltered, or otherwise housed, within the folded cover 12.

Embodiments of the book 10 may further comprise the pages 11 being bound with a helix (coil or spiral) component 13, the component 13 being configured of one or more varying materials such as metal, plastic, composites and the like.

Embodiments of the book 10 may further comprise the cover 12 being hinged at hinge points 17 for folding around the helix (coil or spiral) component 13. Opposing hinge points 17 may define therebetween a spine 18 of the book 10. Embodiments of the book 10 may further comprise the cover 12 being a single flat surface, or a flat back cover 14, that is not scored, or otherwise marked with hinge points 17, for folding or creating a spine 18.

Referring now to FIG. 2, embodiments of the book 10 may further comprise the cover 12 being folded in a closed position around the pages 11, which are coupled to the component 13, which is coupled to the back surface 14 of the cover 12, such that the cover 12 houses the pages 11 much like a conventional book might house its pages. The cover 12 and the spine 18 may be wrapped around the component 13 and the pages 11, such that the back cover 14 protects the underside of the pages, the spine 18 wraps around and protects the component 13 (concealed from view in FIG. 2), and the front cover of the cover 12 wraps around and protects the top surface of the pages 11. Once the book 10 is folded into the closed position, as shown in FIG. 2, the hinged points 17 may define edges of the spine 18. In other words, the hinge points 17 may define where the back cover, or back surface 14, meets the spine 18 and where the front cover meets the spine 18.

Referring now to FIG. 3, embodiments of the book 10 may further comprise two parallel rows of cover holes 15 configured in the back surface 14 of the cover 12. Embodiments of the book 10 may further comprise the back surface 14 comprising the entire cover 12.

In the embodiments of the book 10, the parallel rows of cover holes 15 may be offset, in a direction of travel of the rows, an offset distance 19 to one another, as depicted in FIG. 3, such that a cover hole 15 in the first row of parallel rows is not aligned with a corresponding cover hole 15 in the second row of parallel rows along a line perpendicular to the direction of travel of the rows. Each of the cover holes 15 may be punched, die-cut or similarly made through the flat surface, or back cover 14, of the cover 12. The cover holes 15 may be of varying size and shape and the like, as determined by the size and shape of the book 10, the component 13, and/or the pages 11.

Embodiments of the book 10 may further comprise the two parallel rows of cover holes 15 being offset a distance 19 from one another by a variable that corresponds to the angle 20 of the helix (coil or spiral) component 13 with respect to a line that is perpendicular to the axis of the helix (coil or spiral) component 13. In this way, the helix (coil or spiral) component 13 is not subject to torque when positioned within the cover holes 15.

Embodiments of the book 10 may further comprise the parallel rows of cover holes 15 being set apart from one another at varying distances on the back cover 14 to accommodate varying diameters of the helix (coil or spiral) component 13. As the distance between the parallel rows of cover holes 15 is increased, the variable that defines the offset distance 19 likewise increases based on the rules of geometry and trigonometry.

Embodiments of the book 10 may further comprise the back cover 14 being a single flat surface onto which pages 11 are attached may be of varying size, shape and use, such as a cover, a self-cover, a backing, a support or the like.

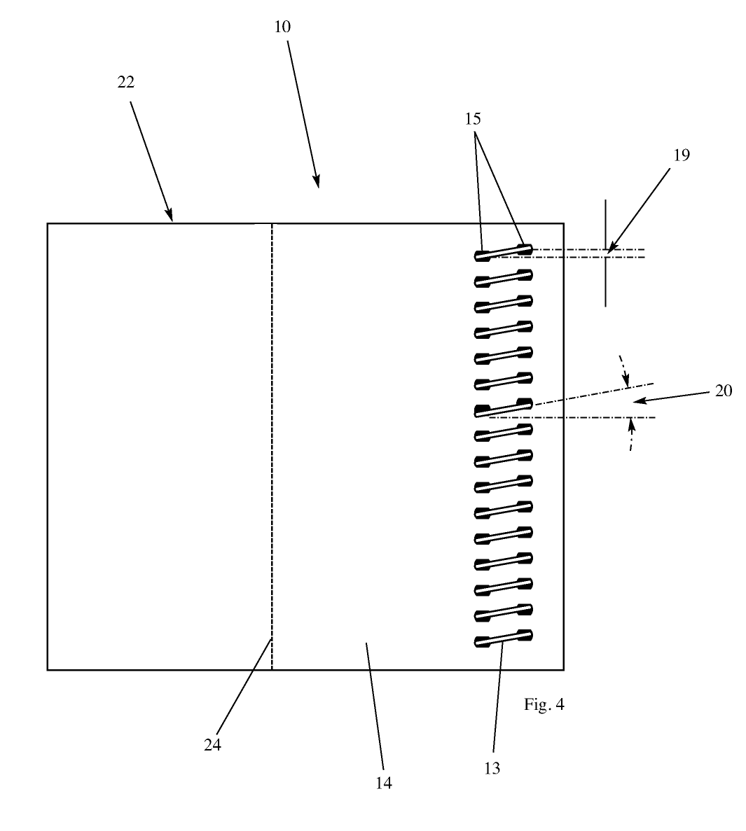

Referring now to FIG. 4, embodiments of the book 10 may comprise a perforation 24 being configured in the back cover 14. The perforation 24 may be aligned with the rows of cover holes 15, such that the perforation 24 and the rows of cover holes 15 are substantially parallel with one another. Moreover, the perforation 24 may be aligned with one or more of the hinge points 17, such that when the book 10 is in the closed position, the perforation 24 and the edge of the spine 18, defined by the hinge point 17 between the back cover 14 and the spine 18, are substantially parallel with one another. The perforation 24 may further define a part 22 of the back cover 14. Embodiments of the book 10 may further comprise the part 22 being configured to be bent about the back cover 14 along the perforation 24, such that the part 22 is repositioned on top of the back cover 14 or underneath the back cover 14. Embodiments of the book 10 may further comprise the part 22 being configured to be separated, detached, or otherwise removed from the remaining portion of the back cover 14 along the perforation 24. Accordingly, the part 22 may be removed completely from the book 10 and used separately therefrom. The part 22 may have printed thereon book information, such as, but not limited to, a book summary, author information, publisher and copyright information, or additional information, such as, but not limited to, a recipe, an advertisement, or a warranty, depending on the contents of the book 10.

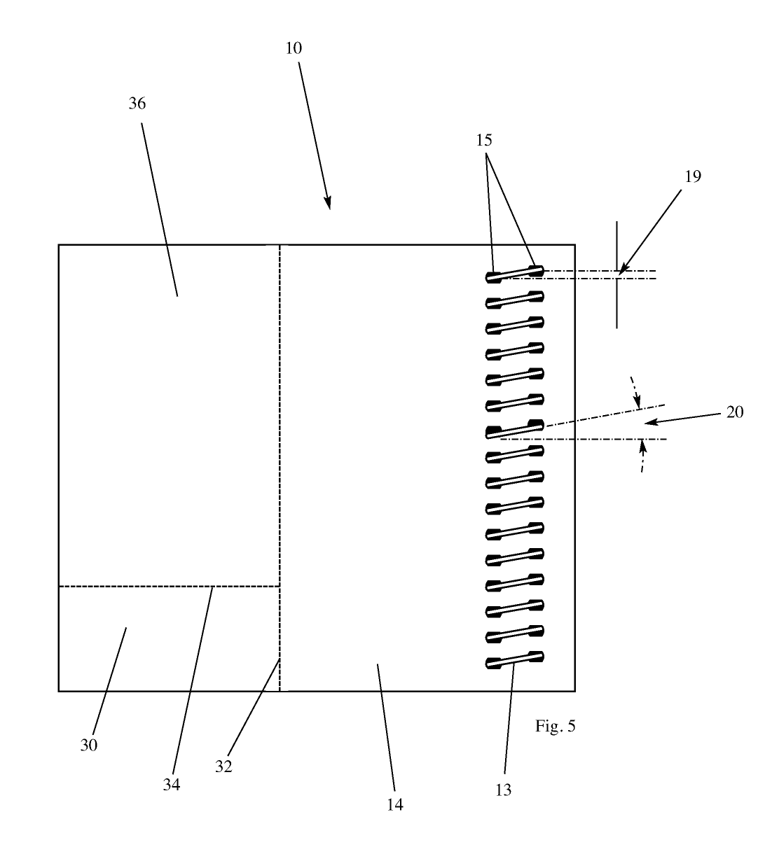

Referring now to FIG. 5, embodiments of the book 10 may comprise a perforation 32 being configured in the back cover 14. The perforation 32 may be aligned with the rows of cover holes 15, such that the perforation 32 and the rows of cover holes 15 are substantially parallel with one another. Moreover, the perforation 32 may be aligned with one or more of the hinge points 17, such that when the book 10 is in the closed position, the perforation 32 and the edge of the spine 18, defined by the hinge point 17 between the back cover 14 and the spine 18, are substantially parallel with one another. Embodiments of the book may further comprise a perforation 34 being configured in the back cover 14 between the perforation 32 and an edge of the book 10. The perforation 34 may be configured to run orthogonal to the perforation 32. The perforations 32 and 34 may define a first part 30 and a second part 36 in the back cover 14. The first part 30 and the second part 36 may be configured on the back cover 14 on one side of the perforation 32 and the helix (coil or spiral) component 13 may be configured on the back cover 14 on the other side of the perforation 32.

Embodiments of the book 10 may further comprise the first part 30 and second part 36 being configured to be bent about the back cover 14 along the perforation 32, such that the parts 30 and 36 may be repositioned on top of the back cover 14 or underneath the back cover 14. Embodiments of the book 10 may further comprise the parts 30 and 36 being configured to be separated, detached, or otherwise removed from the remaining portion of the back cover 14 along the perforation 32. Accordingly, the parts 30 and 36 may be removed completely from the book 10 and used separately therefrom. Moreover, embodiments of the book 10 may further comprise the parts 30 and 36 being configured to be bent with respect to one another along the perforation 34, such that the parts 30 and 36 may be pivoted with respect to one another along the perforation 34. Embodiments of the book 10 may further comprise the parts 30 and 36 being configured to be separated, detached, or otherwise removed from each other along the perforation 34. Accordingly, the parts 30 and 36 may be removed completely from one another and used separately therefrom.

Each of the parts 30 and 36 may have printed thereon book information, such as, but not limited to, a book summary, author information, publisher and copyright information, or additional information, such as, but not limited to, a recipe, an advertisement, business information, contact information, or a warranty card, depending on the contents and/or purpose of the book 10. Additionally, each of the parts 30 and 36 may function as a business card, having the business and/or contact information thereon of the entity affiliated with the book 10.

The advantages of the present invention include, without limitation, that the helix (coil or spiral) component 13 when inserted to two rows of cover holes 15 that are offset from one another to correspond to the angle of the helix (coil or spiral) 20 cut in the back cover, or single flat surface, will not be subject to torque and will remain aligned with the two rows of parallel cover holes 15. Such a configuration permits the pages 11, rotatably coupled to the component 13, to easily rotate about the component 13.

Further, the advantages of the present invention include, without limitation, that books, workbooks, manuals, flip charts, and similar materials comprised of pages bound to a cover, multiple covers, a flat surface or multiple flat surfaces in this method will lay flat when opened fully.

Further, the advantages of the present invention include, without limitation, that covers hinged to form a cased-in (self) cover in this method will permit imprinting or similar identification on the spine or cover without interference by the helix (coil or spiral) binding component.

Embodiments of the book 10 may further comprise a binding method, described herein. The binding method may accommodate attaching pages or flat sheets to a cover using a helix component coupled to the cover and the pages. The method may further comprise using two rows of parallel holes on the cover that are offset to one another. The helix component may be coupled to the cover and the pages by threading the helix component through the rows of parallel holes on the cover as well as through the holes in the pages.

Embodiments of the method may further comprise providing a cover and cutting two rows of offset holes into the cover for the purpose of holding a coil (spiral helix) wire to bind pages of a book to the cover. The two rows of offset holes are a unique feature that permits the coil (spiral helix) wire, made of metal, plastic, or other composites, to be held in alignment with the spine of the book.

The cover may be configured to wrap around the coil (spiral helix) of a finished book. Embodiments of the method may further comprise imprinting onto the spine of the book for the purpose of being able to know the title or other identifying features of a book when it is archived on a shelf, in a stack, lying against another book, or in another type of file where the front cover may be concealed, or otherwise not visible to be seen.

In contrast to the present disclosure, traditional methods of attaching backings or self-covers in binding books using wire have utilized twin loop wire. The advantages of utilizing coil (spiral helix) wire of the present disclosure is that it uses less material and is commonly available in more colors, material choices (e.g., plastics and recycled materials) and has a different aesthetic to that of the twin loop wire method. Advantages of binding books (i.e., booklets, manuals, workbooks, guide books, etc.) using a coil (spiral helix) wire binding of the present disclosure are that the book may lay flat when opened and pages may be easily customized as single sheet insertions using a variety of printing and demand printing methods.

A disadvantage of conventional coil (spiral helix) wire binding is that a self-cover has not been an option due to the fact that die-cutting dies and machinery for cutting two rows of holes have been engineered solely for twin loop type wire binding components, of which the two rows of holes are not offset, but configured so that each row of holes is directly opposite one another and perpendicular to the alignment of the rows of holes. In contrast, the unique cutting method of the present disclosure requires cutting holes in any number of methods (e.g., die-cutting, punching, laser cutting or by other methods) so that each row is offset from other rows in a direction of travel of the rows, the offset corresponding to the angle of the helix of the coil (spiral helix) to be used to hold pages onto the backing or self-cover.

The primary advantages of the present disclosure include without limitation:

That coil (spiral helix) wire may be used to bind flat sheets (pages) to a section of the backing or self-cover, enabling the remaining sections of the backing or self-cover to extend past the coil (spiral helix) for forming a wrap-around cover or other form of specialized cover or backing. Such uses include books, booklets, manuals, workbooks, flip-charts or other forms of binding flat sheets to backings or covers.

Coil (spiral helix) wire is available in more varieties (colors, materials, recycled materials and options) than other wire binding types, such as twin loop wire.

A self-cover that wraps around allows for imprinting on the spine, concealing the coil (spiral helix) wire when the bound item is displayed on a shelf, in a file or other configuration where only the spine may be seen, to thus protect the coil. This also permits visibility of the title, name or other identifier which has traditionally not been accommodated with coil (spiral helix) binding methods due to the fact that the coil (spiral helix) is exposed as the spine and the angle of the helix was not accommodated in two rows of binding holes that were not offset from each other.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

What is claimed is:

1. A book apparatus, comprising:
a book cover having hinged portions that define a back section, a middle section, and a front section of the book cover, the middle section being configured between the hinged portions, the book cover being configured to transition between an open position and a closed position;
a plurality of rows of holes being configured in the back section of the book cover;
a binding component functionally coupled to the plurality of rows of holes; and
pages functionally coupled to the binding component and configured to rotate about the binding component,
wherein in the open position the front section, middle section, and back section are configured to lay flat on a surface with the binding component and pages exposed on the back section, and
wherein in the closed position the book cover is configured to bend about the hinged portions to wrap the book cover over the binding component and the pages to cover the binding component and the pages.

2. The book apparatus of claim 1, wherein the plurality of rows of holes are aligned on the back section, such that the rows are of holes substantially in parallel with one another.

3. The book apparatus of claim 1, wherein the plurality of rows of holes are aligned on the back section, such that the rows of holes are substantially in parallel with the hinged portions.

4. The book apparatus of claim 1, wherein the binding component is positioned on one side of the hinged portions and functionally coupled only to the back section, such that the middle section and the front section move independently of the binding component.

5. The book apparatus of claim 1, wherein the book cover comprises first and second hinged portions, wherein the middle section is configured to bend with respect to the back section about the first hinged portion, and the front section is configured to bend with respect to the middle section about the second hinged portion, such that in the closed position the middle section is configured proximate the binding component and the front section is configured proximate the pages.

6. The book apparatus of claim 1, wherein the plurality of rows of holes are offset an offset distance from one another in the direction of travel of the row of holes.

7. The book apparatus of claim 6, wherein the binding component is a helical coil and the offset distance corresponds to an angle of the helical coil.

8. A book apparatus, comprising:
a book cover having two hinged portions that define a back section, a middle section, and a front section of the book cover, the middle section being configured between the two hinged portions, the book cover being configured to transition between an open position and a closed position;
two rows of holes being configured only in the back section of the book cover, the two rows of holes being aligned substantially in parallel with the two hinged portions;
a perforation being configured in the back section of the book cover, the perforation being aligned substantially in parallel with the two rows of holes; and
a helical coil functionally coupled to the two rows of holes by threading the helical coil through each of the two rows of holes; and
wherein in the open position the front section, middle section, and back section are configured to lay flat on a surface with the helical coil exposed on the back section, and
wherein in the closed position the book cover is configured to bend about the hinges to surround the helical coil, the middle section being configured to bend about the first hinged portion with respect to the back section and the front section being configured to bend about the second hinged portion with respect to the middle section, such that the middle section is proximate the helical coil and the front section extends over the back section.

9. The book apparatus of claim 8, wherein the perforation defines a bendable part of the back section, the bendable part being configured to bend about the perforation with respect to the remainder of the back section.

10. The book apparatus of claim 8, wherein the perforation defines a removable part of the back section, the removable part being configured to detach from the remainder of the back section at the perforation.

11. The book apparatus of claim 8, wherein the perforation comprises a first preformation and a second perforation, the first perforation being aligned in parallel with the rows of holes and defining a part of the back section, the second perforation being configured on the part and aligned orthogonal to the first perforation, such that the second perforation divides the part of the back section into a first part and a second part, and wherein the first and second parts are bendable about the first perforation with respect to the remainder of the back section and the first and second parts are bendable about the second perforation with respect to one another.

12. The book apparatus of claim 11, wherein the first and second parts are configured to be detached from the remainder of the back section along the first perforation and the first and second parts are configured to be detached from one another along the second perforation.

13. A method of binding a book, the method comprising:
providing a book cover having hinged portions defining a back section, a middle section, and a front section of the book cover, the book cover configured to lay flat;
forming a plurality of rows of holes in the back section of the cover;
functionally coupling a binding component to the plurality of rows of holes;
functionally coupling loose-leaf pages to the binding component; and
folding the middle section and the front section at the hinge portions over the binding component and the pages to position the binding component and the pages between the back section and the front section.

14. The method of claim 13, wherein the bending the middle section and the front section at the hinge portions further comprises moving the middle section with respect to the back portion at the first hinged portion; and moving the front section with respect to the middle portion at the second hinged portion.

15. The method of claim 13, wherein the plurality of rows of holes are parallel with one another.

16. The method of claim 13, wherein the plurality of rows of holes are parallel with the hinged portions.

17. The method of claim 13, wherein the forming a plurality of rows of holes further comprises punching the plurality of rows of holes with machinery.

18. The method of claim 13, wherein the forming a plurality of rows of holes further comprises offsetting the plurality of rows of holes an offset distance from one another in a direction of travel of the rows of holes.

19. The method of claim 13, wherein the functionally coupling a binding component further comprises threading a helical coil through the plurality of rows of holes, and wherein the functionally coupling loose-leaf pages further comprises threading a helical coil through holes in the pages.

20. The method of claim 13, wherein the middle section defines a spine of the book, and the method further comprises imprinting identifying information on the spine, such that under the condition the middle section and front section are folded over the binding component and the pages, the information on the spine is visible.
